(19) United States
(12) Patent Application Publication
(10) Pub. No.: US 2014/0229578 A1
(43) Pub. Date: Aug. 14, 2014

(54) ASYNCHRONOUSLY COMMUNICATING A LINK TO A SHARED COLLECTION

(71) Applicant: DROPBOX, INC., San Francisco, CA (US)

(72) Inventor: Kevin L. Chu, Cupertino, CA (US)

(73) Assignee: Dropbox, Inc., San Francisco, CA (US)

(21) Appl. No.: 13/764,318

(22) Filed: Feb. 11, 2013

(51) Int. Cl. H04L 29/06

(52) U.S. Cl. CPC H04L 65/60
USPC 709/219

(57) ABSTRACT

The disclosed embodiments relate to a feature of a content-item-uploading system that enables a user to instruct the content-item-uploading system to provide a link to a content item after the content item finishes uploading to an online content management system (for example, to their Dropbox™). During operation, the system receives an instruction to upload the content item to the online content management system. In response to the instruction, the system commences uploading of the content item. Then, the system receives another instruction to communicate the link to a designated recipient, where the link specifies a location from which the designated recipient can download the content item. After the content item finishes uploading, the system communicates the link to the designated recipient.

### BACKGROUND

1. Field

The disclosed embodiments generally relate to techniques for sharing content items, such as files. More specifically, the disclosed embodiments relate to a system that facilitates sharing a content item by asynchronously communicating a link to a content item to a designated recipient after the content item finishes uploading to an online content management system.

2. Related Art

Users of an online content management system, such as the Dropbox™ service, provided by Dropbox, Inc. of San Francisco, Calif., often desire to share their files with other individuals. For example, a user may provide a link to a recipient that specifies a location where the recipient can download a file from the online content management system.

However, the link to the file can only be enabled after the file is uploaded to the online content management system. If the user is uploading a large file or if there is a slow network connection, there may be a significant delay before the link is enabled. As a consequence, the user may have to send multiple messages to the recipient (such as a first message with a disabled link and a subsequent message with an enabled link), or the user may have to wait until the file finishes uploading to send the link to the recipient. This cumbersome procedure degrades the user's experience and, thus, may decrease the user's satisfaction with the online content management system.

### SUMMARY

The disclosed embodiments relate to a feature of a content-item-uploading system which improves the user experience by allowing a user to instruct the system to provide a link to a content item (which is sometimes referred to as a ‘share link’) after the content item finishes uploading to a server. For example, the server can be part of an online content management system (such as Dropbox™). In particular, while the content item is uploading to the server, the user may instruct the system to provide the link to the content item to a designated recipient once the content item finishes uploading. Subsequently, when the content item finishes uploading, the system may communicate the link to the content item to the designated recipient. This ‘fire-and-forget’ approach makes such messaging significantly less cumbersome for the user. Moreover, the system can provide the link using a variety of communication protocols, including: email, text messaging, a rich site summary (RSS) feed, etc.

### BRIEF DESCRIPTION OF THE FIGURES

FIG. 1 illustrates a content management environment, which includes an online content management system in accordance with the disclosed embodiments.

FIG. 2 presents a flow chart illustrating a process for providing a link to a content item in accordance with the disclosed embodiments.

FIG. 3 presents a flow chart illustrating the process of FIG. 2 in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Content Management Environment

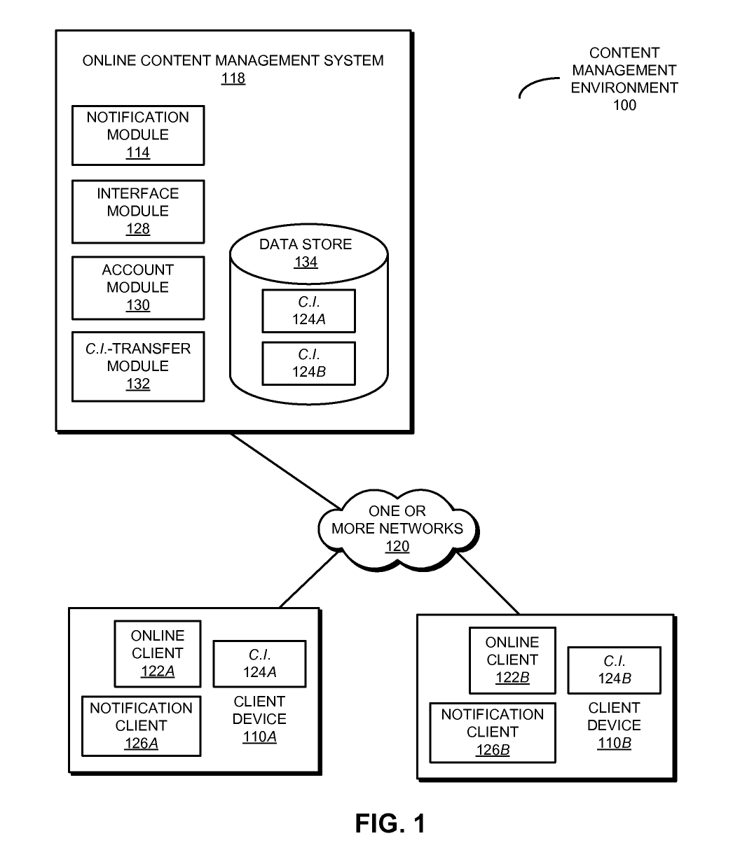

FIG. 1 shows content management environment 100 according to various embodiments. As may be understood from this figure, content management environment 100 includes a plurality of client devices 110A and 110B (collectively 110), and an online content management system 118 (also referred to as a “content management system”), which are all interconnected by one or more networks 120. Various aspects of the client devices 110 and content management system 118 are discussed below.

Client Devices

In various embodiments, each client device 110 may selectively execute an online-service client application 122A and 122B (collectively 122) (also referred to as an “online client”), which may be used to manage content items (which may include files, such as audio, video, music, word-processor or data files, types of content or data having one or more formats, folders or containers that include multiple files or types of content, etc.) stored within a content management system 118. It is noted that, in some embodiments, synchronized copies of content items (C.I.) 124A and 124E may be kept on content management system 118 and each respective client device 110. In some embodiments, client devices 110 may provide a file-browser type interface (not shown) for directly manipulating the content items stored on content management system 118 without maintaining a local copy. Client devices 110 may also include notification clients 126A and 126B (collectively 126) for receiving and sending messages associated with notification module 114. For example, the messages may include: text messages, emails, rich site summary (RSS) feeds, etc. Note that notification clients 126A and 126B can be web-based or native-client-based notification clients.

While only two client devices 110A and 110B are shown in FIG. 1, for purposes of clarity, it should be understood by those skilled in the relevant field that many client devices 110A and 110B may simultaneously connect through network(s) 120 to content management system 118 at any given time. Examples of suitable client devices 110 include, but are not limited to, a desktop computer; mobile computing devices, such as a laptop or a tablet; and handheld devices, such as a smartphone (e.g., an IPHONE®, BLACKBERRY®, or ANDROID™-based smartphone). Each client device 110 may store a local, synced copy of one or more content items from within content management system 118, and the content items may be stored in any suitable content-item format. When online client 122 presents content items that are stored within the content-item storage system to a user, the content items may be arranged in folders (or containers) and the folders themselves may be arranged in other folders, or in any other arbitrary arrangement supported by content management system 118, as determined by the user. However, one of skill in the art should understand in light of this disclosure that each user's content-item-storage architecture may be considerably different from the next, and in some instances, the content-item-storage architecture may be implemented to maximize storage and content-item retrieval efficiency.

Content Management System

Content management system 118 stores content items and manages access to the content items via client devices 110. Content management system 118 and its components may be implemented using any appropriate hardware and software for content-item serving, storage, and retrieval functions. For example, content management system 118 may be implemented in the form of a single server or multiple servers.

In various embodiments, content management system 118 includes: notification module 114, interface module 128, account module 130, content-item-transfer module 132, and data store 134. Each of these elements of content management system 118 is discussed below.

Notification Module

Notification module 114 may communicate information with client devices 110 and, in particular, with notification clients 126. For example, as described further below, notification module 114 may notify one of notification clients 126 in one of client devices 110 (which is associated with a designated recipient) of a link to an uploaded content item.

Content Management System—Interface Module

In particular embodiments, interface module 128 may facilitate content-item access and content-item storage among content management system 118 and client devices 110. Interface module 128 may receive content items from and send content items to client devices 110 consistent with the user's preferences for sharing content items. Interface module 128 may act as the counterpart to a client-side content-item-explorer style user interface that allows a user to manipulate content items directly stored on content management system 118. In some embodiments, software operating on client devices 110 may integrate network-stored content items with the client's local content-item system to enable a user to manipulate network-stored content items through the same user interface (UI) used to manipulate content items on the local content-item system, e.g., via a file explorer, file finder or browser application. As an alternative or supplement to the client-side content-item-explorer interface, interface module 128 may provide a web interface for client devices 110 to access (e.g., via a suitable online client 122) and allow a user to manipulate content items stored within content management system 118. In this way, the user can directly manipulate content items stored within content management system 118.

Content Management System—Data Store

In various embodiments, data store 134 may store content items such as those uploaded using client devices 110, or using any other suitable computing device. In the embodiment illustrated in FIG. 1, client device 110A, which is associated with a first user, is shown as locally storing at least content item 124A, and client device 110B, which is associated with a second user, is shown as locally storing at least content item 124B. As shown in FIG. 1, copies of the locally stored content items are maintained in data store 134 of content management system 118.

In various embodiments, data store 134 may maintain information identifying the user, information describing the user's content-item directory, and other information in a content-item journal that is maintained for each user. In some embodiments, the content-item journal may be maintained on content management system 118, and in other embodiments, a content-item journal (e.g., a ‘server-side content-item journal’) may be maintained on content management system 118 and locally on each client device 110. In various embodiments, the content-item journal may be used to facilitate the synchronization of the various copies of a particular content item that are associated with a user's account.

As a particular example, in the embodiment shown in FIG. 1, the system may be configured so that any changes that are made to content item 124A on particular client device 110A may also be automatically reflected in the copy of content item 124A stored within content management system 118 (subject to the delay, if any, associated with uploading content item 124A or the changes to content item 124A from client device 110A to content management system 118). Similarly, any changes that are made to content item 124A on content management system 118 may also be automatically reflected in the copy of content item 124A stored on client device 110A (subject to the delay, if any, associated with downloading content item 124A or the changes to content item 124A from content management system 118 to client device 110A).

Content Management System—Account Module

In particular embodiments, account module 130 may track content items stored in data store 134 and entries in the server-side content-item journal for each content item. As users grant content-item access permissions to other users, account module 130 may update the server-side content-item journal associated with each relevant user in data store 134. Account module 130 may also track client devices 110 that are associated with each user's account. For example, a user may want to share all their content items among their desktop computer, tablet computer, and mobile device. To make such a sharing arrangement seamless to the user, the user's single account on content management system 118 may be associated with each of the user's respective client devices. In some embodiments, an application running on each respective client device 110 may help to coordinate synchronization of content items on the client device with corresponding versions of the content items within the user's account in content management system 118, and also with corresponding versions of the content items stored on the user's various other client devices.

Content Management System—Content-Item-Transfer Module

In various embodiments, content item-transfer module 132 may track content items that are uploaded to data store 134, or downloaded from data store 134. When a content item is uploaded to data store 134, content-item-transfer module 132 may notify notification module 114, which may provide a link to a designated recipient that specifies a location where the content item can be downloaded. For example, a user of content management system 118 may use interface module 128 to: specify the designated recipient, provide instructions to upload the content item and/or provide the link. In addition, the user may use interface module 128 to indicate a time interval when the content item may be downloaded and/or a number of times the designated recipient can download the content item. These link-management options may be enforced by content-item-transfer module 132 and/or account module 130.

Notification Process

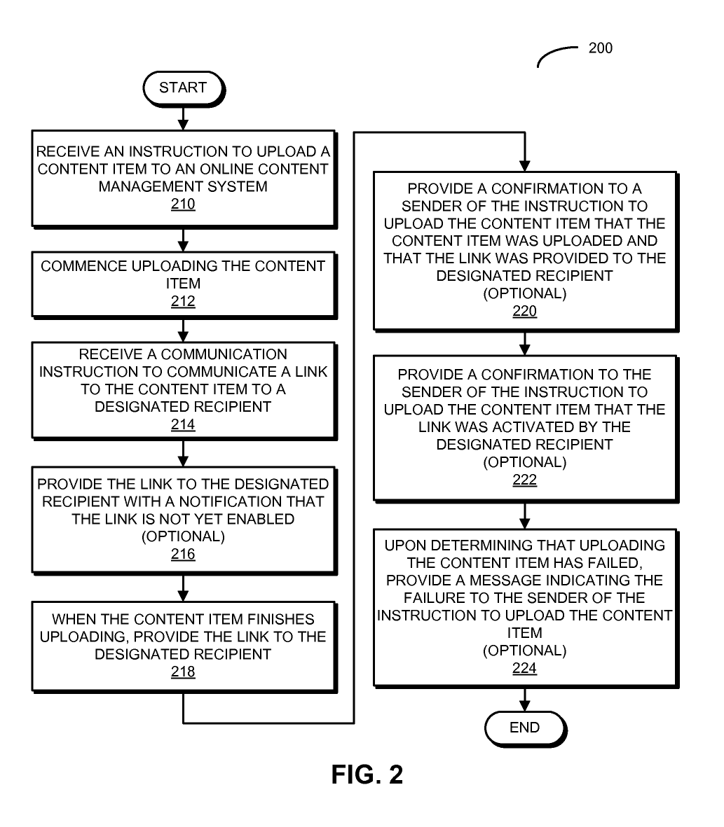

FIG. 2 presents a flow chart illustrating a process 200 for providing a link (such as a share link) to a content item (such as a file, a document or a type of data having an associated format, a folder or a container), which may be performed by a system. For example, process 200 may be performed by modules or components in content management system 118 in FIG. 1, including: account module 130 and notification module 114. During operation, the system receives an instruction to upload the content item to an online content management system (operation 210). For example, the user of client device 110A may use online client 122A to instruct content management system 118 to upload content item 124A in FIG. 1.

In response to the instruction, the system commences uploading of the content item (operation 212). For example, interface module 128 may commence uploading content item 124A to data store 134 in FIG. 1. This uploading process may be tracked by content-item-transfer module 132, and a summary of available content items and their states in data store 134 may be maintained by account module 130 in FIG. 1.

Then, the system receives a communication instruction to communicate the link to the content item to a designated recipient (operation 214), where the link specifies a location from which the designated recipient can download the content item. For example, the user of client device 110A may use online client 122A to add the communication instruction to a pending queue associated with content-item-transfer module 132 in FIG. 1.

When the content item finishes uploading, the system provides the link to the designated recipient (operation 218). For example, content-item-transfer module 132 may provide the communication instruction to notification module 114 in FIG. 1, which then provides or communicates the share link to the designated recipient, such as a user of client device 110B. This share link may be presented to the user of client device 110B by notification client 126B in FIG. 1. Note that a wide variety of communication techniques or protocols may be used to provide the share link, including: email, text messaging, a rich site summary (RSS) feed, etc.

In this way, the system may hold off sending or providing the link until the content item has been fully uploaded (i.e., until after the uploading of the content item is complete) without further action by a sender of the instruction to upload the content item. This delayed or asynchronous notification process enhances the user experience, and thus increases customer satisfaction and retention.

In some embodiments, the system optionally provides a confirmation to a sender of the instruction to upload the content item that the content item was uploaded and that the link was provided to the designated recipient (operation 220). Moreover, the system may optionally provide a message to a sender that the link was activated by the designated recipient (operation 222). Alternatively, upon determining that uploading of the content item has failed, the system may optionally provide a message indicating the failure to a sender of the instruction to upload the content item (operation 224). For example, content-item-transfer module 132 may provide an instruction to notification module 114 in FIG. 1, which in turn provides or communicates any of the preceding messages to the sender, who can, for example, by the user of client device 110A. These messages may be presented to the user of client device 110A by notification client 126A in FIG. 1.

In an exemplary embodiment, the link includes a link to a web page. For example, the link may include a uniform resource locator (URL) to the web page. More generally, the URL may specify where the content item is located on data store 134 in FIG. 1. When activated by the designated recipient, notification client 126B in FIG. 1 displays the web page on client device 110B. This web page includes one or more icons or buttons that the designated recipient can activate to download the content item.

Note that the content item may be associated with a container that includes multiple content items, including at least one that was previously uploaded. In this embodiment, the link may be associated with the container. Depending on the privileges defined by the sender, the designated recipient may be able to access or download other content items in the container in addition to the content item.

While the preceding example illustrates the delayed communication of an enabled share link, in other embodiments the system may send the link immediately, but may notify the recipient that the content item is not ready. Thus, in some embodiments, prior to completion of the uploading of the content item, the system optionally provides the link to the designated recipient with a notification that the link is not enabled yet (operation 216). The message with the inactive link may also include an estimate as to when the uploading will finish (i.e., when the content item will be ready). For example, the disabled link may be included in a message with a progress or status bar that tracks the progress of the content-item upload. In this embodiment, the system subsequently provides the link with a message that the link is enabled (i.e., that the content item is actually available). For example, the link may include sensory information (such as a color, a symbol, a font, bold text, underlining, and/or another visual indicator) that indicates that the link is enabled.

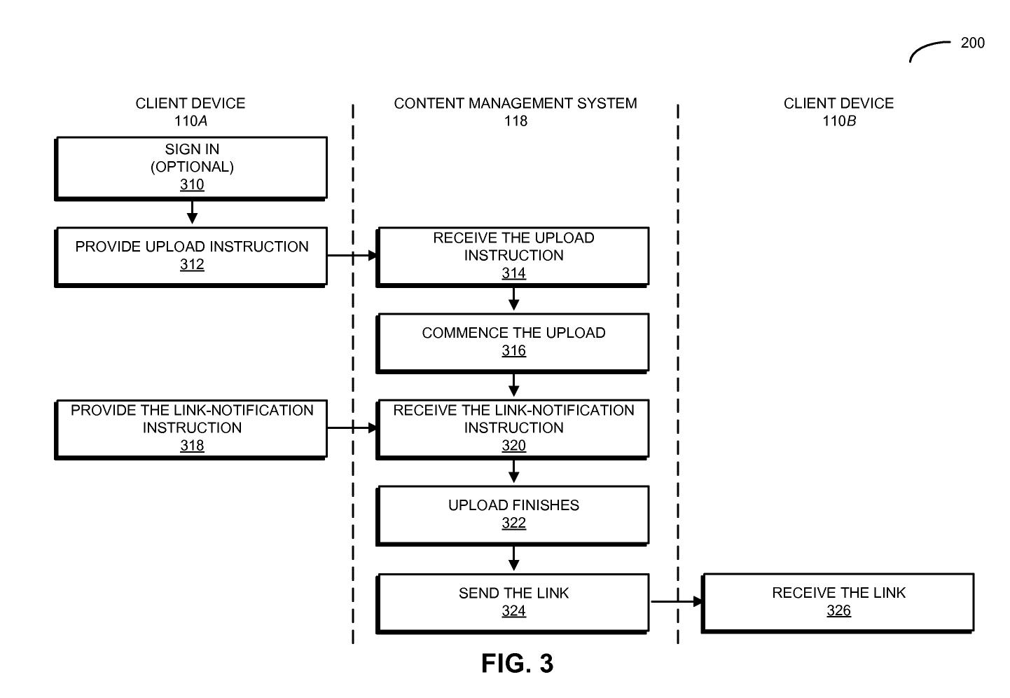

Process 200 is further illustrated in FIG. 3, which shows the interaction among client device 110A, content management system 118 and client device 110B. For example, a user of client device 110A may wish to upload and share a content item with at least the user of client device 110B (the designated recipient). If the user is not signed in to the online content management system, the user may optionally sign in (operation 310). For example, a dialog box may be displayed that enables the user to sign in to (and if necessary to sign up with) the online content management system.

Then, the user may provide the upload instruction (operation 312). For example, the user may access the online content management system via a web browser, and the user may explicitly trigger or directly provide the upload instruction by selecting or activating an upload button. Alternatively, the user may implicitly trigger or indirectly provide the upload instruction by saving (or dragging) the content item to a folder in a client application (such as online client 122A).

After this instruction is received (operation 314), the uploading may commence (operation 316). While the content item is uploading, content management system 118 may pop up a status bar indicating that the content item is presently uploading. In addition, content management system 118 may also pop up a dialog box that provides a selection interface that allows the user to select a destination folder in content management system 118. The user subsequently selects a destination folder. Note that overlapping this destination-selection process with the uploading operation can save a significant amount of time and can improve the user's experience.

In one embodiment, the selection interface allows the user to access a website which is hosted in content management system 118. This website provides a content-item system view into the user's account on content management system 118 and allows the user to navigate through a hierarchical directory structure. For efficiency, this content-item system view may only list folders and does not display the individual content items within the folders.

Before the uploading is finished, the user may also provide the link-notification instruction (operation 318), which is received by content management system 118 (operation 320). For example, the user may activate an icon or a button in the selection interface. In response, a pop up may be displayed, which allows the user to designate the message recipient, thereby instructing content management system 118 to provide the link to the message recipient.

When the uploading finishes (operation 322), the content item is placed in the selected destination folder, and content management system 118 sends the link (operation 324), which is then received by the designated recipient (operation 326). Content management system 118 may also indicate to the user (i.e., the sender) that the content item has successfully uploaded and that the link was sent to the designated recipient.

While the preceding discussion illustrated the content-management process with a user providing the instruction to upload the content item, in other embodiments the upload instruction is provided by the online client (such as online client 122A). In these embodiments, the instruction to upload the content may be provided automatically without direct user action. For example, the user may have previously specified that the online content management system should perform data backup and/or content-item synching (such as daily, whenever a content item is modified on a client device or when a content item is stored in a folder on a client device, etc.). During an instance of the data backup and/or the content-item synching, one or more content items may then be uploaded by the online client without further action by the user.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A computer-implemented method for providing a link to a content item, the method comprising:
using a computer, receiving an instruction to upload the content item to a server;
in response to the instruction, commencing uploading of the content item;
receiving another instruction to communicate the link to the content item to a designated recipient, wherein the link specifies a location from which the designated recipient can download the content item; and
when the content item finishes uploading, providing the link to the designated recipient.

2. The method of claim 1, wherein the server is an online content management system.

3. The method of claim 1, wherein the method further comprises providing a confirmation to a sender of the instruction to upload the content item that the content item was uploaded and that the link was provided to the designated recipient.

4. The method of claim 1, wherein the method further comprises providing a message to a sender of the instruction to upload the content item that the link was activated by the designated recipient.

5. The method of claim 1, wherein, upon determining that the uploading of the content item has failed, the method further comprises providing a message indicating the failure to a sender of the instruction to upload the content item.

6. The method of claim 1, wherein the content item is associated with a container that includes multiple content items;
wherein at least one of the content items was previously uploaded; and
wherein the link is associated with the container.

7. The method of claim 1, wherein the link is provided to the designated recipient after the uploading of the content item is complete without further action by a sender of the instruction to upload the content item.

8. The method of claim 1, wherein, prior to completion of the uploading of the content item, the method further comprises providing the link to the designated recipient with a notification that the link is not enabled yet; and
wherein the method further comprises subsequently providing the link again with notification that the link is enabled.

9. The method of claim 1, wherein the link includes sensory information that indicates that the link is enabled.

10. The method of claim 1, wherein the instruction to upload the content item is triggered by a sender issuing an upload request for the content item.

11. The method of claim 1, wherein the instruction to upload the content item is triggered by a sender storing the content item in a folder on a client device.

12. The method of claim 1, wherein the instruction to upload the content item is received from a client application after one of: a time interval has elapsed since the content item has been saved to a folder associated with the client application; or the content item has been changed.

13. A computer-program product for use in conjunction with a computer system, the computer-program product comprising a non-transitory computer-readable storage medium and a computer-program mechanism embedded therein to provide a link to a content item, the computer-program mechanism including:
instructions for receiving an instruction to upload the content item to the computer system;
in response to the instruction, instructions for commencing uploading of the content item;
instructions for receiving another instruction to communicate the link to the content item to a designated recipient, wherein the link specifies a location from which the designated recipient can download the content item; and
when the content item finishes uploading, instructions for providing the link to the designated recipient.

14. The computer-program product of claim 13, wherein the computer-program mechanism further comprises instructions for providing a confirmation to a sender of the instruction to upload the content item that the content item was uploaded and that the link was provided to the designated recipient.

15. The computer-program product of claim 13, wherein the computer-program mechanism further comprises instructions for providing a message to a sender of the instruction to upload the content item that the link was activated by the designated recipient.

16. The computer-program product of claim 13, wherein, upon determining that the uploading of the content item has failed, the computer-program mechanism further comprises instructions for providing a message indicating the failure to a sender of the instruction to upload the content item.

17. The computer-program product of claim 13, wherein the content item is associated with a container that includes multiple content items;
wherein at least one of the content items was previously uploaded; and
wherein the link is associated with the container.

18. The computer-program product of claim 13, wherein the link is provided to the designated recipient after the uploading of the content item is complete without further action by a sender of the instruction to upload the content item.

19. The computer-program product of claim 13, wherein, prior to completion of the uploading of the content item, the computer-program mechanism further comprises:
instructions for providing the link to the designated recipient with a notification that the link is not enabled yet; and
instructions for subsequently providing the link again with notification that the link is enabled.

20. The computer-program product of claim 13, wherein the instruction to upload the content item is triggered by a sender issuing an upload request for the content item.

21. The computer-program product of claim 13, wherein the instruction to upload the content item is triggered by a sender storing the content item in a folder on a client device.

22. The computer-program product of claim 13, wherein the instruction to upload the content item is received from a client application after one of: a time interval has elapsed since the content item has been saved to a folder associated with the client application; or the content item has been changed.

23. A computer system, comprising:
a processor;
memory; and
a program module, wherein the program module is stored in the memory and configurable to be executed by the processor to provide a link to a content item, the program module including:
instructions for receiving an instruction to upload the content item to the computer system;
in response to the instruction, instructions for commencing uploading of the content item;
instructions for receiving another instruction to communicate the link to the content item to a designated recipient, wherein the link specifies a location from which the designated recipient can download the content item; and
when the content item finishes uploading, instructions for providing the link to the designated recipient.

24. The computer system of claim 23, wherein the program module further comprises instructions for providing a confirmation to a sender of the instruction to upload the content item that the content item was uploaded and that the link was provided to the designated recipient.

25. The computer system of claim 23, wherein the program module further comprises instructions for providing a message to a sender of the instruction to upload the content item that the link was activated by the designated recipient.

26. The computer system of claim 23, wherein, upon determining that the uploading of the content item has failed, the program module further comprises instructions for providing a message indicating the failure to a sender of the instruction to upload the content item.
